(19) United States
(12) Patent Application Publication
(10) Pub. No.: US 2025/0391913 A1
(43) Pub. Date: Dec. 25, 2025

(54) NEGATIVE ELECTRODE FOR LITHIUM SECONDARY BATTERY AND LITHIUM SECONDARY BATTERY COMPRISING THE SAME

(71) Applicants: Hyundai Motor Company, Seoul (KR); Kia Corporation, Seoul (KR); Korea Advanced Institute of Science and Technology, Daejeon (KR)

(72) Inventors: Jongchan Song, Hwaseong (KR); Won Keun Kim, Hwaseong (KR); Areum Ha, Hwaseong (KR); Jae Wook Shin, Hwaseong (KR); Seungjong Lee, Hwaseong (KR); Jihee Ham, Hwaseong (KR); Kyoung Han Ryu, Hwaseong (KR); Seongmin Ha, Hwaseong (KR); Hee-Tak Kim, Daejeong (KR); Youngil Roh, Daejeong (KR)

(21) Appl. No.: 19/242,134

(22) Filed: Jun. 18, 2025

(30) Foreign Application Priority Data
Jun. 20, 2024 (KR) 10-2024-0080561

(51) Int. Cl. H01M 10/0565; H01M 4/02; H01M 4/134; H01M 10/0525; H01M 10/0568; H01M 10/0569

(52) U.S. Cl. CPC H01M 10/0565; H01M 4/134; H01M 10/0525; H01M 10/0568; H01M 10/0569; H01M 2004/021; H01M 2004/027

(57) ABSTRACT

The present disclosure relates to a negative electrode for lithium rechargeable battery, comprising: a current collector; a lithium-based negative electrode active material layer positioned on the current collector; and a protective layer positioned on the lithium-based negative electrode active material layer, wherein, the protective layer comprises a gel polymer electrolyte and a lithium-ion conductive nano particle, the gel polymer electrolyte comprises a lithium-ion derived from lithium salt, an anion, an organic solvent, and a polymer, and a lithium-ion binding energy of the anion is greater than that of the organic solvent.

### CROSS-REFERENCE TO RELATED APPLICATION

This application claims under 35 U.S.C. § 119(a) the benefit of Korean Patent Application No. 10-2024-0080561 filed in the Korean Intellectual Property Office on Jun. 20, 2024, the entire contents of which are incorporated herein by reference.

### BACKGROUND

### Technical Field

The present disclosure relates to a negative electrode for a lithium rechargeable battery and a lithium rechargeable battery including the same.

### Background

Batteries using lithium metal negative electrodes are attracting attention as next-generation lithium rechargeable batteries with high capacity and high energy. Representative examples include lithium metal batteries, lithium sulfur batteries, and lithium air batteries. Since lithium metal used as the negative electrode has low density (0.54 g/cm³) and low standard reduction potential (−3.040 V vs. SHE), it affords an exceptionally high theoretical capacity (3860 mAh/g) and outstanding gravimetric and volumetric energy densities.

However, lithium metal batteries suffer from forming lithium dendrites and low coulomb efficiency. During the electrochemical cycle of a battery, lithium dendrites and dead lithium are formed on the lithium metal negative electrode, causing loss of active material. Lithium metal forms a passive layer (Solid Electrolyte Interphase; SEI) on the surface through reactions with electrolytes and residual moisture due to its high reactivity. However, the passive layer is broken and re-formed repeatedly due to the increase in the surface area of the electrode caused by the creation of lithium dendrites and inert lithium (dead lithium). Therefore, continuous consumption of lithium metal and electrolyte occurs, lowering coulomb efficiency and shortening cell cycle life. Additionally, if lithium dendrites grow through the separator, an internal short circuit may occur, which may lead to safety issues such as fire or explosion. Therefore, in order to implement a high-performance and high-safety lithium metal battery, a strategy to induce uniform lithium growth and reduce electrolyte decomposition is essential.

To induce uniform lithium, conventional art designs electrolytes in which many anions are coordinated around lithium-ions and form an inorganic SEI layer through anion decomposition. This SEI layer has the characteristics of high mechanical strength, fast ion conduction behavior, and uniform composition, which induces more dense lithium growth.

However, to manufacture a high energy density lithium metal battery, a lean electrolyte is essential, and in this case, the battery life-span is mostly determined by the electrolyte depletion factor rather than the depletion factor of available lithium. Therefore, there is an urgent need to develop technology to reduce electrolyte decomposition.

### SUMMARY

Accordingly, one task of the present disclosure is to provide a negative electrode for a lithium rechargeable battery and a lithium rechargeable battery including the same, which can improve the life-span characteristics of the battery by reducing electrolyte decomposition.

One embodiment of the present disclosure provides a negative electrode for lithium rechargeable battery, comprising:

A current collector; a lithium-based negative electrode active material layer positioned on the current collector; and a protective layer positioned on the lithium-based negative electrode active material layer, wherein, the protective layer comprises a gel polymer electrolyte and a lithium-ion conductive nano particle, the gel polymer electrolyte comprises a lithium-ion derived from lithium salt, an anion, an organic solvent, and a polymer, and a lithium-ion binding energy of the anion is greater than that of the organic solvent.

The negative electrode for the lithium rechargeable battery can satisfy the following Equation 1.

$${BE}_{Li} ( anion ) - {BE}_{Li} ( organic solvent ) \geq 0.25 ( eV ) \qquad [ Equation 1 ]$$

In the Equation 1, BE_{Li}(anion) is the lithium-ion binding energy of the anion, and BE_{Li}(organic solvent) is the lithium-ion binding energy of the organic solvent.

The average lithium-ion concentration of the lithium-ion conductive nano particle can be higher than the average lithium-ion concentration of the gel polymer electrolyte.

The gel polymer electrolyte and lithium-ion conductive nano particles form an interface region between them, and a lithium-ion concentration gradient can exist in the interface region.

The average lithium-ion concentration of the lithium-ion conductive nano particle can be greater than 30 M.

The average lithium-ion concentration of the gel polymer electrolyte can be less than 3 M.

The interface region can form a space charge composed of lithium-ions.

The coordination number between lithium-ion and anion in the interface region can be less than 1.

The coordination number between lithium-ion and organic solvent in the interface region can be less than 0.5.

The coordination number between lithium-ion and -lithium-ion conductive nano particles in the interface region can be more than 50% of the entire coordination number of lithium-ions.

The lithium salt may be LiFSI (Lithium Bis(fluorosulfonyl)imide), LiTFSI (Lithium bis(trifluoromethanesulfonyl)imide), LiBF₄ (Lithium tetrafluoroborate), LiPF₆ (Lithium hexafluorophosphate), LiBOB (Lithium bis(oxalato)borate) or a combination thereof. there is.

The organic solvent may be FSA (N,N-dimethylsulfamoyl fluoride), DME (1,2-dimethoxyethane), FEC (Fluoroethylene carbonate) or a combination thereof.

The polymer is formed by cross-linking a polymerization compound, and the polymerization compound can be PEGDA (Poly(ethylene glycol) diacrylate), PEGDMA (polyethylene glycol dimethacrylate), PEG (poly(ethylene glycol)), EGDMA (Ethylene glycol dimethacrylate), PEGDE (Poly(ethylene glycol) diglycidyl ether) or a combination thereof.

The molecular weight of the polymerization compound can be 500 to 5,000 g/mol.

The molecular weight of the polymer can be from 10,000 to 1,000,000.

The lithium-ion conductive nano particle may be an oxide nano particle.

The lithium-ion conductive nano particle can be an LLZO-based oxide, an LSTP-based oxide, a LATP-based oxide, a LAGP-based oxide, an LLTO-based oxide, a LGPO-based oxide or a combination thereof.

The lithium-ion conductive nano particle may be an LLZO-based oxide represented by the following formula 1.

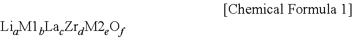

In the above formula 1, M1 is Al, M2 is Ta, Nb, W or combination thereof, 5≤a≤7, 0≤b≤3, 2≤c≤4, 1≤d≤3, 0≤e≤2, and 10≤f≤14.

The average particle diameter D50 of the lithium-ion conductive nano particles can be 100 nm to 5 μm.

The weight ratio of the lithium-ion conductive nano particle and the sum of the lithium salt and polymer (lithium-ion conductive nano particle:lithium salt+polymer) can be 5:5 to 9:1.

The weight ratio of the lithium salt and the polymer (lithium salt:polymer) can be 2:8 to 9:1.

The thickness of the protective layer can be 1 to 20 m.

Another embodiment of the present disclosure provides a lithium rechargeable battery comprising a negative electrode for the aforementioned lithium rechargeable battery.

A negative electrode for a lithium rechargeable battery according to one embodiment of the present disclosure includes a protective layer positioned on a lithium-based negative electrode active material layer, thereby reducing electrolyte decomposition within the battery and improving the life-span characteristics of the battery.

As discussed, the method and apparatus suitably include the use of a controller or processer.

### BRIEF DESCRIPTION OF THE DRAWINGS

FIG. 1 is a schematic view of a negative electrode for a lithium rechargeable battery according to some embodiments of the present disclosure.

FIG. 2 shows an example of a lithium salt and an organic solvent as an impregnation liquid electrolyte used in the manufacture of a protective layer of a negative electrode for a lithium rechargeable battery according to some embodiments of the present disclosure, in chemical formula form.

FIG. 3 is a graph showing the lithium-ion binding affinity of FSI-anion, FSA organic solvent, FEC organic solvent, and DME organic solvent according to Experimental Example 1.

FIG. 4 is a graph evaluating the recovery of electrochemical characteristics (discharge capacity) according to an additional electrolyte injection after the cycle in Experimental Example 2

FIG. 5 is a graph evaluating the recovery of electrochemical characteristics (cell voltage) according to an additional electrolyte injection after the cycle in Experimental Example 2.

FIG. 6 is a graph showing the results of evaluating the electrolyte residual ratio after the cycle according to Experimental Example 2.

FIG. 7 is a result graph of the evaluation of lithium's reversible capacity after cycling according to Experimental Example 2.

FIG. 8 is a Raman spectrum analysis result graph according to Experimental Example 3.

FIG. 9 is a MD snapshot of the SICC/gel-polymer-electrolyte interface, illustrating LI+ space-charge formation according to Experimental Example 4.

FIG. 10 is a graph showing Li_ and major electrolyte-species concentration profiles as a function of distance from the SICC surface.

FIG. 11 is a schematic potential diagram depicting LI+ accumulation at the SICC/electrolyte interface according to Experimental Example 4.

FIG. 12 is a graph showing the coordination number of lithium-ion according to the MD simulation result of Experimental Example 4.

FIG. 13 is a graph showing the simulation result lithium-ion average decomposition voltage evaluation result according to Experimental Example 5.

FIG. 14 is a result graph of the electrolyte decomposition current evaluation using linear sweep voltammetry in a Li/Cu half-cell according to Experimental Example 6.

FIG. 15 is a time-dependent impedance evaluation result graph of a symmetric cell according to Experimental Example 7.

FIG. 16 is a result graph evaluating the initial interface resistance increase over time of a symmetric cell according to Experimental Example 8.

FIGS. 17 and 18 are the result graphs of the life-span characteristic evaluation of a full cell according to Experimental Example 9.

FIG. 19 is a graph showing the 19F NMR analysis results of the residual electrolyte after 10 cycles of full-cell fabrication according to Experimental Example 10.

FIG. 20 is a result graph of the element ratio analysis within the SEI (Solid Electrolyte Interphase) through X-ray photoelectron spectroscopy (XPS) analysis after 10 cycles of full-cell manufacturing according to Experimental Example 10.

FIG. 21 is a result graph of the evaluation of the residual LiFSI fraction according to the cycle progression after manufacturing a full cell according to Experimental Example 10.

FIG. 22 is a cross-section SEM image of a cycled lithium electrode, showing an approximately 3 micrometer porous surface layer revealed by FIB milling according to Experimental Example 11.

FIG. 23 is a cross-section SEM image of a cycled lithium electrode coated with an SICC-GPE composite, displaying an approximately 8 micrometer dense protective layer according to Experimental Example 11.

FIG. 24 is a result graph of the evaluation of the swelling characteristic of the cell according to the progress of the cycle after manufacturing the full cell according to Experimental Example 12.

### DETAILED DESCRIPTION OF THE EMBODIMENTS

Terms such as first, second and third are used to describe, but are not limited to, the various parts, components, region, layers and/or sections. These terms are used only to distinguish one part, component, region, layer, or section from another part, component, area, layer, or section. Accordingly, a first part, component, region, layer or section described herein may be referred to as a second part, component, region, layer or section without departing from the scope of the present disclosure.

The technical terms used herein are intended to refer only to certain exemplary embodiments and are not intended to limit the present disclosure. The singular forms used here include plural forms unless the context clearly indicates the opposite. The meaning of “comprising/including/containing/having” as used in a specification is to specify a particular characteristic, region, integer, step, behavior, element, and/or component, and does not exclude the existence or added any other characteristic, region, integer, step, behavior, element, and/or component.

When a part is “on” or “above” another part, it may be directly on or above the other part, or it may entail another part in between. In contrast, when we say that something is “directly on” of something else, we don't interpose anything between them.

The term “gel polymer electrolyte” herein refers to a polymer matrix swollen with liquid electrolyte solvent(s) that captures the solvent constituents and enables lithium-ion transport through the polymer network while remaining mechanically self-supporting.

The term “lithium-ion binding energy” herein refers to the calculated energy difference between the total energy of a lithium-ion/ligand complex and the sum of the separate energies of the lithium ion and the ligand.

The term “interface region” herein refers to the nanoscale zone that forms at contact between the gel-polymer electrolyte and the lithium-ion-conductive nanoparticle (or other solid phase) and that exhibits compositional and concentration gradients distinct from the adjoining bulk phases.

The term “space-charge layer” herein refers to a charge-imbalanced region that develops at an interface between two materials of different lithium chemical potential.

The term “coordination number,” as applied to Li+ in an electrolyte, herein refers to the number of ligand atoms directly bound within the first solvation shell of a lithium ion.

Unless otherwise defined, all terms used herein, including technical and scientific terms, have the same meaning as commonly understood by a person of ordinary skill in the technical field to which the present disclosure belongs. Commonly used dictionary-defined terms are further construed to have meanings consistent with the relevant technical literature and the present disclosure and are not to be construed in an idealized or highly formal sense unless defined.

Also, unless otherwise noted, “%” refers to “wt %”, where 1 ppm is 0.0001 wt %.

In this specification, the term “combination thereof(s)” described in a Markush format expression means one or more mixtures or combinations selected from the group consisting of components described in the Markush format expression and means including one or more selected from the group consisting of the components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Below, an embodiment is described in detail so that a person of ordinary skill in the technical field to which the present disclosure belongs can easily carry out the present disclosure. As those skilled in the art would realize, the described embodiments may be modified in various different ways, all without departing from the spirit or scope of the present disclosure.

### 1. Negative Electrode for Lithium Rechargeable Battery

An electrolyte containing a solvent with low lithium coordination ability or a high concentration lithium salt can control the deposition density of lithium by forming a thin and stable passivation layer (SEI; Solid Electrolyte Interface) on the lithium metal surface by increasing the coordination of anions around lithium-ions and inducing negative ion decomposition.

However, if an excess of anions exists in the lithium-ion solvation structure, anions are continuously consumed at the positive electrode and negative electrode during the battery cycling process, and the degree of lithium-ion coordination anions gradually decreases. Accordingly, the oxidation stability of the electrolyte also decreases, resulting in cell degradation. Therefore, suppressing the decomposition of anions in a lean electrolyte environment is an essential element for achieving excellent life-span characteristics of a high energy density lithium metal battery.

Accordingly, the present inventors, through repeated research, have discovered that by further positioning a protective layer according to the present disclosure on a lithium-based negative electrode active material layer, electrolyte decomposition within the battery can be reduced, thereby improving the life-span characteristics of the battery, and thus completing the present disclosure.

Specifically, a negative electrode for a lithium rechargeable battery according to one embodiment of the present disclosure includes a current collector; a lithium-based negative electrode active material layer positioned on the current collector; and a protective layer positioned on the lithium-based negative electrode active material layer.

The protective layer includes a gel polymer electrolyte and lithium-ion conductive nano particles, and the gel polymer electrolyte includes lithium-ions derived from lithium salt and anions, and an organic solvent and a polymer.

At this time, the lithium-ion binding energy of the anion is greater than the lithium-ion binding energy of the organic solvent.

More specifically, the negative electrode for the lithium rechargeable battery can satisfy the following Equation 1.

$${BE}_{Li} ( anion ) - {BE}_{Li} ( organic solvent ) \geq 0.25 ( eV ) \qquad [ Equation 1 ]$$

In the Equation 1, BE_{Li}(anion) is the lithium-ion binding energy of the negative ion, and BE_{Li}(organic solvent) is the lithium-ion binding energy of the organic solvent.

In this way, when the lithium-ion binding energy of the anion in the protective layer is greater than the lithium-ion binding energy of the organic solvent, or preferably satisfies Equation 1, the oxygen of the lithium-ion conductive nano particle surface and the polymer in the gel polymer electrolyte can actively participate in the lithium-ion coordination of the electrolyte. Accordingly, the existing solvation structure in which a large number of anions are coordinated to lithium-ions can be broken, and as a result, the life-span characteristics of the battery can be improved. Lithium-ions over-coordinated by anions rapidly deplete anions through reactions between lithium metal and negative electrodes, and this depletion of anions reduces the oxidation stability of electrolytes and promotes positive electrode degeneration, resulting in degradation of the battery's life-span characteristics.

Additionally, the negative electrode according to the present disclosure may have an average lithium-ion concentration of lithium-ion conductive nano particles higher than the average lithium-ion concentration of the gel polymer electrolyte. Accordingly, the gel polymer electrolyte and lithium-ion conductive nano particles form an interface region between them, and a lithium-ion concentration gradient may exist in the interface region.

When a lithium-ion concentration gradient exists in the interface region like this, a space charge (Free Li⁺) composed only of lithium-ions can be formed due to the chemical potential difference of the lithium-ions. This space charge is mainly coordinated with polymer or lithium-ion conductive nano particles, so that much less electrolyte coordination can be observed compared to conventional electrolytes or gel polymer electrolytes. In this way, the reduced lithium-ion-electrolyte coordination at the interface region can drastically reduce electrolyte decomposition during the lithium electrodeposition process and preferably improve the life-span characteristics of the resulting battery.

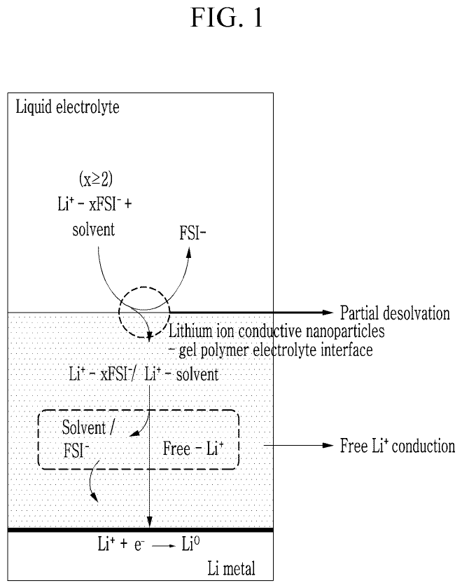

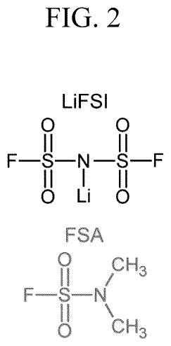

In relation to this, FIG. 1 is a conceptual diagram of a negative electrode for a lithium rechargeable battery according to some embodiments of the present disclosure, showing the formation process of a space charge composed only of lithium-ions. However, FIG. 1 shows LiFSI (Lithium Bis(fluorosulfonyl)imide) as an example of a lithium salt and FSA (N,N-dimethylsulfamoyl fluoride) as an example of an organic solvent, but this is only an example and the lithium salt and organic solvent according to the present disclosure are not necessarily limited thereto. In addition, FIG. 2 shows examples of lithium salt and organic solvent as liquid electrolytes for impregnation used in the manufacture of a protective layer of a negative electrode for a lithium rechargeable battery according to some embodiments of the present disclosure, which are represented as chemical formulas of LiFSI and FSA, respectively.

Specifically, the average lithium-ion concentration of the lithium-ion conductive nano particle can be greater than or equal to 30 M, and more specifically, greater than or equal to 35 M. Additionally, the average lithium-ion concentration of the gel polymer electrolyte may be less than 3 M, and more specifically less than 2 M. When the average lithium-ion concentration of lithium-ion conductive nano particles and gel polymer electrolyte satisfies the range, space charge is formed more efficiently in the interface region, and lithium-ion-electrolyte coordination is reduced, so that the effect of improving the life-span characteristics of the battery can be more preferably realized.

Additionally, the coordination number between lithium-ion and anion in the interface region may be 1 or less, and more specifically, 0.8 or 0.5 or less. Additionally, the coordination number between the lithium-ion and the organic solvent in the interface region may be 0.5 or less, and more specifically, 0.45 or less. When the coordination number between lithium-ion and anion in the interface region and the coordination number between lithium-ion and organic solvent are sufficiently low, such as in the range, the effect of improving the life-span characteristics of the battery can be more preferably realized.

Additionally, the coordination number between lithium-ion and -lithium-ion conductive nano particles in the interface region may be 50% or more of the entire coordination number of lithium-ions, and more specifically, 55% or more. In this way, since the ratio of the coordination number between lithium-ion and lithium-ion conductive nano particle is sufficiently large, the coordination number between lithium-ion and anion and the coordination number between lithium-ion and organic solvent are relatively reduced, so that the effect of improving the life-span characteristics of the battery can be more preferably realized.

The lithium salt may be LiFSI (Lithium Bis(fluorosulfonyl)imide), LiTFSI (Lithium bis(trifluoromethanesulfonyl)imide), LiBF₄ (Lithium tetrafluoroborate), LiPF₆ (Lithium hexafluorophosphate), LiBOB(Lithium bis(oxalato)borate) or a combination thereof. there is.

The organic solvent may be FSA (N,N-dimethylsulfamoyl fluoride), DME (1,2-dimethoxyethane), FEC (Fluoroethylene carbonate) or a combination thereof.

At this time, the lithium salt and the organic solvent can be appropriately selected and combined so that the anion and lithium-ion binding energy of the organic solvent among the listed compounds are in the range according to the present disclosure, i.e., preferably satisfying Equation 1.

Preferably, as an example, the lithium salt can be LiFSI and the organic solvent can be FSA. When lithium salt and organic solvent are selected as the compound, the lithium-ion binding energy thereof satisfies the range according to the present disclosure, so that the effect of improving the life-span characteristics of the battery can be preferably realized.

Meanwhile, the polymer is formed by cross-linking a polymerization compound, and the polymerization compound can be PEGDA (Poly (ethylene glycol) diacrylate), PEGDMA (polyethylene glycol dimethacrylate), PEG (poly (ethylene glycol)), EGDMA (Ethylene glycol dimethacrylate), PEGDE (Poly (ethylene glycol) diglycidyl ether) or a combination thereof. When the polymerization compound is like this, there may be an advantage in reducing lithium-ion coordination by the electrolyte by having the functional group of the compound coordinate to the lithium-ion.

The molecular weight of the polymerizable compound can be 500 to 5,000 g/mol, more specifically 500 to 2,000 g/mol or 500 to 1,000 g/mol. If the molecular weight of the polymerizable compound is too small, there may be a problem of low ion conductivity due to insufficient electrolyte swelling after polymerization. If the molecular weight of the polymerizable compound is too large, there may be a problem in that the durability of the protective layer becomes weak due to excessive electrolyte swelling after polymerization.

The molecular weight of the polymer can be from 10,000 to 1,000,000. If the molecular weight of the polymer is too small, the durability of the protective layer may become compromised as the effectiveness as a binder decrease. If the molecular weight of the polymer is too large, there may be a problem of low ion conductivity due to a decrease in the mobility of the polymer chain to which lithium-ions are coordinated.

The lithium-ion conductive nano particle may be an oxide nano particle. At this time, the lithium-ion conductive nano particle can be LLZO-based oxide, LSTP-based oxide, LATP-based oxide, LAGP-based oxide, LLTO-based oxide, LGPO-based oxide or a combination thereof.

More specifically, the lithium-ion conductive nano particle may be an LLZO-based oxide represented by the following formula 1. When lithium-ion conductive nano particles are like this, there may be an advantage of maximizing the chemical potential with the gel polymer electrolyte due to the high internal lithium-ion concentration.

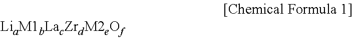

In the above formula 1, M1 is Al, M2 is Ta, Nb, W or combination thereof, 5≤a≤7, 0≤b≤3, 2≤c≤4, 1≤d≤3, 0≤e≤2, and 10≤f≤14.

At this time, the average particle diameter D50 of the lithium-ion conductive nano particle can be 100 nm to 5 km. If the average particle diameter D50 of lithium-ion conductive nano particles is too small, there may be a problem with the durability of the protective layer. If the average particle diameter D50 of lithium-ion conductive nano particles is too large, there may be a problem of reduced lithium-ion conduction through the interface with the gel polymer electrolyte. In this specification, the average particle diameter D50 can be defined as the particle diameter corresponding to 50% of the volume accumulation amount on the particle diameter distribution curved line. The average particle diameter D50 can be measured, for example, using the laser diffraction method.

The weight ratio of the lithium-ion conductive nano particle and the sum of the lithium salt and polymer (lithium-ion conductive nano particle:lithium salt+polymer) can be 5:5 to 9:1. If the content of lithium-ion conductive nano particles is too low compared to the sum of lithium salt and polymer, there may be a problem of reduced lithium-ion conduction through the lithium-ion conductive nanoparticle and gel polymer electrolyte interface. If the content of lithium-ion conductive nano particles is too large compared to the sum of lithium salt and polymer, there may be a problem of reduced lithium-ion conduction through the lithium-ion conductive nanoparticle and gel polymer electrolyte interface.

The weight ratio of the lithium salt and the polymer (lithium salt:polymer) can be 2:8 to 9:1. If the content of the lithium salt is too low compared to the polymer, there may be a problem of reduced dissociated lithium-ion conduction by the swollen polymer. If the lithium salt content is too high compared to the polymer, there may be a problem of reducing the protective layer binding effect through the polymer.

The thickness of the protective layer can be 1 to 20 m, more specifically 5 to 15 m. If the thickness of the protective layer is too small, there may be a problem in that the effect of improving the life-span characteristics due to the introduction of the protective layer is minimal. If the thickness of the protective layer is too large, there may be problems with excessive resistance increase and decreased energy density of the battery.

Meanwhile, the lithium-based negative electrode active material layer may be a conventional one including lithium metal or a lithium alloy (e.g., an alloy of lithium and metals such as aluminum, zinc, bismuth, cadmium, antimony, silicon, lead, tin, gallium or indium), and therefore, a detailed description thereof will be omitted.

### 2. Manufacturing Method of Negative Electrode for Lithium Rechargeable Battery

Another embodiment of the present disclosure provides a method for manufacturing a negative electrode for a lithium rechargeable battery, comprising the steps of: preparing a lithium-based negative electrode active material layer; applying and drying a solution for forming a protective layer containing lithium-ion conductive nano particles, a first lithium salt, and a polymerizable compound on the lithium-based negative electrode active material layer to form a pre-protective layer; and impregnating the pre-protective layer with a liquid electrolyte for impregnation containing a second lithium salt and an organic solvent to form a protective layer in which a gel polymer electrolyte is formed.

Hereinafter, a manufacturing method of a negative electrode for a lithium rechargeable battery according to another embodiment of the present disclosure is described in detail step by step.

First, a lithium-based negative electrode active material layer is prepared.

The lithium-based negative electrode active material layer may be a conventional one including lithium metal or a lithium alloy (e.g., an alloy of lithium and metals such as aluminum, zinc, bismuth, cadmium, antimony, silicon, lead, tin, gallium or indium), and may be prepared by a method conventionally used in the art.

Next, a solution for forming a protective layer containing lithium-ion conductive nano particles, first lithium salt, and a polymerizable compound is applied and dried on the lithium-based negative electrode active material layer to form a pre-protective layer.

During the coating and drying process, the polymerization compounds are cross-linked to each other to form a cross-linked polymer, and thus a pre-protection layer including lithium-ion conductive nano particles and polymers in a state before impregnation, swelling, and gelling by the liquid electrolyte for impregnation in the step described later can be formed.

The lithium-ion conductive nano particle may be an oxide nano particle. At this time, the lithium-ion conductive nano particle can be LLZO-based oxide, LSTP-based oxide, LATP-based oxide, LAGP-based oxide, LLTO-based oxide, LGPO-based oxide or a combination thereof.

More specifically, the lithium-ion conductive nano particle may be an LLZO-based oxide represented by the following formula 1. The benefits of this are as explained above, so they are omitted.

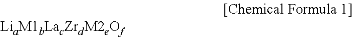

In the above formula 1, M1 is Al, M2 is Ta, Nb, W or combination thereof, 5≤a≤7, 0≤b≤3, 2≤c≤4, 1≤d≤3, 0≤e≤2, and 10≤f≤14.

The polymerization compound is PEGDA (Poly(ethylene glycol) diacrylate), PEGDMA(polyethylene glycol dimethacrylate), PEG(poly(ethylene glycol)), EGDMA(Ethylene glycol dimethacrylate), PEGDE(Poly(ethylene glycol) diglycidyl ether) or combination. The benefits of this are as explained above, so they are omitted.

The first lithium salt is LiFSI(Lithium Bis(fluorosulfonyl)imide), LiTFSI(Lithium bis(trifluoromethanesulfonyl)imide), LiBF₄(Lithium tetrafluoroborate), LiPF₆(Lithium hexafluorophosphate), LiBOB(Lithium bis(oxalato)borate) or a combination thereof.

The solvent used in the solution for forming the protective layer may be, for example, EC (Ethylene carbonate), DEC (Diethylene carbonate) or a mixed solvent thereof.

The drying can be performed at a temperature range of about 40 to 80° C. and can be performed for about 5 to 15 hours.

Next, a liquid electrolyte for impregnation containing a second lithium salt and an organic solvent is impregnated into the pre-protective layer to form a protective layer in which a gel polymer electrolyte is formed.

Through the impregnation, a gel polymer electrolyte can be formed by impregnating and swelling the polymer within the pre-protection layer with the liquid electrolyte for impregnation and gelation.

Through the impregnation, a gel polymer electrolyte can be formed by impregnating and swelling the polymer within the pre-protection layer with the liquid electrolyte for impregnation and gelation.

The organic solvent may be FSA (N,N-dimethylsulfamoyl fluoride), DME (1,2-dimethoxyethane), FEC (Fluoroethylene carbonate) or a combination thereof. the organic solvent [symbol] FSA(N,N-dimethylsulfamoyl fluoride), DME (1,2-dimethoxyethane), FEC(Fluoroethylene carbonate) or combination thereof.

The second lithium salt may be LiFSI(Lithium Bis(fluorosulfonyl)imide), LiTFSI(Lithium bis(trifluoromethanesulfonyl)imide), LiBF4(Lithium tetrafluoroborate), LiPF6(Lithium hexafluorophosphate), LiBOB(Lithium bis(oxalato)borate) or a combination thereof. You can. the second lithium salt [symbol] LiFSI(Lithium Bis(fluorosulfonyl)imide), LiTFSI(Lithium bis(trifluoromethanesulfonyl)imide), LiBF₄(Lithium tetrafluoroborate), LiPF₆(Lithium hexafluorophosphate), LiBOB(Lithium bis(oxalato)borate) or combination thereof.

The first lithium salt and the second lithium salt may be the same or different, but preferably they may be the same. The first lithium salt can play a role in slowing down the degeneration of the battery due to depletion of the second lithium salt during the cycling process by maintaining a constant lithium salt concentration inside the battery.

Accordingly, a negative electrode for a lithium rechargeable battery according to one embodiment of the present disclosure having a structure in which a protective layer including a gel polymer electrolyte and lithium-ion conductive nano particles is positioned on a lithium-based negative electrode active material layer can be manufactured.

### 3. Lithium Rechargeable Battery

Another embodiment of the present disclosure provides a lithium rechargeable battery comprising a negative electrode for the aforementioned lithium rechargeable battery.

The lithium rechargeable battery may more specifically include a positive electrode, a negative electrode positioned opposite the positive electrode, a separator interposed between the positive electrode and the negative electrode, and an electrolyte.

The negative electrode is as described above.

Additionally, the lithium rechargeable battery may further selectively include a battery container that accommodates an electrode assembly of a positive electrode, a negative electrode, a separator, and a sealing member that seals the battery container.

The positive electrode may include a positive electrode current collector, and a positive electrode active material layer disposed on the positive electrode current collector, and the positive electrode active material layer may include a positive electrode active material.

The positive electrode current collector is not particularly limited as long as it has conductivity and does not cause chemical changes in the battery, and for example, stainless steel, aluminum, nickel, titanium, sintered carbon, or surface treatment of aluminum or stainless steel with carbon, nickel, titanium, silver, or the like, can be used. In addition, the positive electrode current collector can typically have a thickness of 3 to 500 m, and fine protrusions and depressions can be formed on the positive electrode current collector surface to increase the adhesive strength of the positive electrode active material. It can be used in various forms such as film, sheet, foil, net, porous body, foam, non-woven fabric, etc.

A compound that can reversibly intercalate and deintercalate lithium (lithiated intercalation compound) can be used as the positive electrode active material. Specifically, at least one of the composite oxides of a metal selected from cobalt, manganese, nickel, and a combination thereof and lithium may be used, and a specific example thereof may be a compound expressed by one of the following formulas:

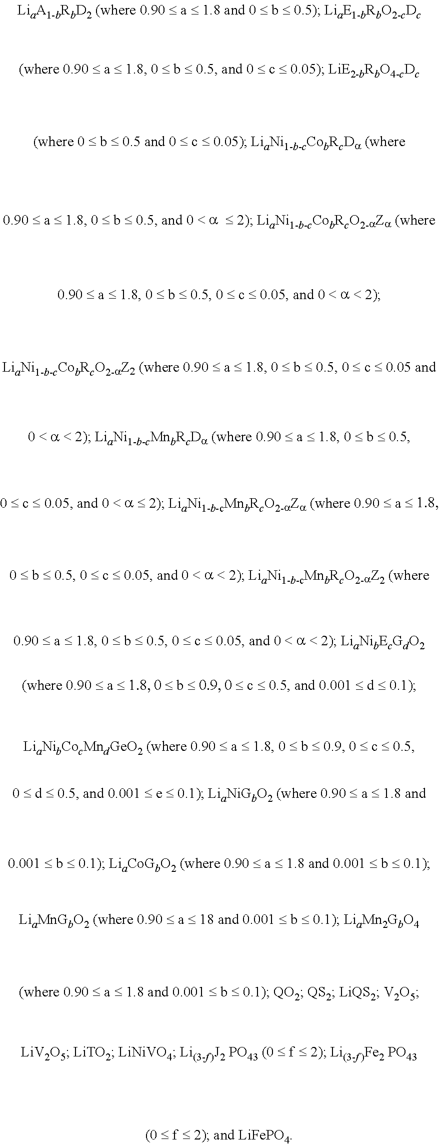

In the above formula, A is Ni, Co, Mn, or a combination thereof; R is Al, Ni, Co, Mn, Cr, Fe, Mg, Sr, V, a rare earth element, or a combination thereof; D is O, F, S, P, or combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

Of course, it is also possible to use a compound having a coating layer on the compound surface or a mixture of the compound and the coating layer.

The coating layer may include at least one coating element compound selected from the group consisting of an oxide of the coating element, a hydroxide of the coating element, an oxyhydroxide of the coating element, an oxycarbonate of the coating element and a hydroxycarbonate of the coating element. The compounds forming these coating layers can be amorphous or crystalline. The coating elements included in the coating layer may include Mg, Al, Co, K, Na, Ca, Si, Ti, V, Sn, Ge, Ga, B, As, Zr or mixture thereof. The coating layer forming process can be performed by any coating method (e.g., spray coating, immersion method, etc.) that does not adversely affect the properties of the positive electrode active material by using these elements in the compound. Since this is well-understood by those working in the field, a detailed explanation will be omitted.

The positive electrode active material layer may further include a binder and/or conductive material together with the aforementioned positive electrode active material.

The binder serves to improve the adhesion between positive electrode active material particles and the adhesive strength between the positive electrode active material and the positive electrode current collector. Specific examples include polyvinylidene fluoride (PVDF), vinylidenefluoride-hexafluoropropylene copolymer (PVDF-co-HFP), polyvinylalcohol, polyacrylonitrile (polyacrylonitrile), carboxylmethyl cellulose (CMC), starch, hydroxypropyl cellulose, regenerated cellulose, polyvinylpyrrolidone, polytetrafluoroethylene, polyethylene, polypropylene, ethylene-propylene-diene monomer rubber (EPDM rubber), sulfonated-EPDM, styrene butadiene rubber (SBR), fluorine rubber, or various copolymers thereof. One of these may be used alone or as a mixture of two or more but is not limited thereto. The binder can be included in an amount of 1 to 30 wt % based on the total weight of the positive electrode active material layer.

The conductive material is used to provide conductivity to the electrode and can be used without special restrictions in the battery as long as it does not cause chemical changes and has electron conductivity. Specific examples include graphite such as natural graphite or artificial graphite; carbon-based materials such as carbon black, acetylene black, Ketjen black, channel black, furnace black, lamp black, summer black, and carbon fiber; metal powder or metal fiber such as copper, nickel, aluminum, and silver; conductive whiskers such as zinc oxide, potassium titanate, and the like; conductive metal oxides such as titanium oxide; or conductive polymers such as polyphenylene derivatives, and the like. One of these may be used alone or as a mixture of two or more of these but is not limited thereto. The conductive material can typically be included in an amount of 1 to 30 wt % based on the total weight of the positive electrode active material layer.

The positive electrode can be manufactured according to conventional positive electrode manufacturing methods.

Specifically, the positive electrode can be manufactured by applying a composition for forming a positive electrode active material layer, including a positive electrode active material and, optionally, a binder, a conductive material or a solvent, on a positive electrode current collector, followed by drying and rolling. At this time, the types and contents of the positive electrode active material, binder, and conductive material are as described above.

The solvent may be a generally-used solvent in the relevant technical field, such as dimethylsulfoxide (DMSO), isopropyl alcohol, N-methylpyrrolidone (NMP), acetone, or water. One of these may be used alone or a mixture of two or more may be used. The amount of the solvent used is sufficient to dissolve or distribute the positive electrode active material, conductive material and binder, taking into consideration the coating thickness and manufacturing yield of the slurry, and to have a viscosity that can exhibit excellent thickness uniformity during subsequent coating for manufacturing the positive electrode.

Alternatively, the positive electrode may be manufactured by casting the composition for forming the positive electrode active material layer on a separate supporter, peeling the resulting film from the supporter, and laminating the resulting film on a positive electrode current collector.

The separator separates the positive electrode and the negative electrode and provides a passage for lithium-ions to move. If it is a separator that is usually used in lithium rechargeable batteries, it can be used without any special restrictions. It is preferably one that has low resistance to ion movement of the electrolyte and excellent electrolyte retention ability. Specifically, a porous polymer film, for example, a porous polymer film manufactured from a polyolefin polymer such as an ethylene homopolymer, a propylene homopolymer, an ethylene/butene copolymer, an ethylene/hexene copolymer, and an ethylene/methacrylate copolymer, or a stacking structure of two or more layers thereof can be used. Additionally, conventional porous non-woven fabrics, such as non-woven fabrics made of high melting point glass fibers, polyethylene terephthalate fibers, etc., may also be used. In addition, a coated separator containing a ceramic component or polymer material may be used to secure heat resistance or mechanical strength and may be selectively used as a single-layer or multi-layer structure.

The electrolyte can be an impregnating electrolyte for forming the aforementioned gel polymer electrolyte.

In addition to the electrolyte components mentioned above, the electrolyte may further include one or more additives, such as haloalkylenecarbonate compounds such as difluoro ethylenecarbonate, pyridine, triethylphosphite, triethanolamine, cyclic ether, ethylene diamine, n-glyme, hexamethylphosphoric acid triamide, nitrobenzene derivative, sulfur, quinone imine dye, N-substituted oxazoleridinone, N,N-substituted imidazoleridine, ethylene glycol dialkyl ether, ammonium salts, pyrrole, 2-methoxy ethanol or trichloride aluminum, for the purpose of improving the life-span characteristics of the battery, suppressing battery capacity decrease, and improving the discharge capacity of the battery. At this time, the additive can be included in an amount of 0.1 to 5 wt % relative to the total weight of the electrolyte.

Below, an implementation example of the present disclosure is described in more detail through embodiment. However, the following embodiment is only a preferable embodiment, and the present disclosure is not limited by the following embodiment.

### Embodiment 1 (Negative Electrode with Protective Layer Formed)

### (1) Preparation of Negative Electrode

A current collector-lithium metal layer laminate was manufactured by stacking a lithium metal layer as a lithium-based negative electrode active material layer on a current collector using a conventional method.

(Preparation of solution for forming a protective layer) After that, Li_{6.4}La₃Zr_{1.4}Ta_{0.6}O₁₂ oxide nano particles (hereinafter referred to as “SICC”) with an average particle diameter D50 of 500 nm, lithium bis(fluorosulfonyl)imide (LiFSI) lithium salt, and PEGDA (Poly(ethylene glycol) diacrylate) polymerizable compound with a molecular weight of 575 g/mol were added to a mixed solvent of EC (Ethylene carbonate) and DEC (Diethylene carbonate) at a volume ratio of 1:1 to form a solution for forming a protective layer. At this time, the weight ratio of the injected Li_{6.4}La₃Zr_{1.4}Ta_{0.6}O₁₂ oxide nano particle:LiFSI (lithium Bis(fluorosulfonyl)imide) lithium salt:PEGDA (poly(ethylene glycol) diacrylate) polymerization compound was 80:10:10.

(Pre-protection layer formation) After that, the solution for forming the protection layer was applied on the lithium metal layer by the doctor blade casting method and dried at a temperature of 60° C. for 10 hours to form a pre-protection layer including a cross-linked polymer of PEGDA (Poly(ethylene glycol) diacrylate) polymerization compound and Li_{6.4}La₃Zr_{1.4}Ta_{0.6}O₁₂ oxide nano particles. (Formation of a protective layer) After that, the pre-protective layer was impregnated with an electrolyte (hereinafter, “F-2 electrolyte”) in which 3.34 M LiFSI was dissolved in FSA (N,N-dimethylsulfamoyl fluoride) solvent as a liquid electrolyte for impregnation, and a protective layer was formed in which a gel polymer electrolyte (hereinafter, also referred to as “GPE”) was formed as the cross-linked polymer swelled by the liquid electrolyte for impregnation.

In this way, a negative electrode having a sequential stacking structure of current collector-lithium metal layer-protective layer was manufactured.

### (2) Preparation of Full Cell

A full cell was manufactured using the manufactured negative electrode, the positive electrode with LiNi_{0.5}Co_{0.2}Mn_{0.3}O₂ positive electrode active material applied, and the same liquid electrolyte for impregnation as above as electrolyte.

### Embodiment 2 (Negative Electrode with Protective Layer Formed)

In the protective layer formation step, the negative electrode and full cell were manufactured in the same manner as in embodiment 1, except that an electrolyte containing 3.34 M LiFSI dissolved in FSA solvent and 1% FEC (Fluoro Ethylene Carbonate) electrolyte additive was used as the liquid electrolyte (hereinafter, “F-3 electrolyte”) for impregnation.

### Comparative Example 1 (Negative Electrode without Protective Layer)

A negative electrode of a current collector-lithium metal layer laminate (i.e., a negative electrode without a protective layer formed compared to embodiment 1) was manufactured by laminating a lithium metal layer as a lithium-based negative electrode active material layer on a current collector using a conventional method. In addition, a full cell was manufactured by configuring the negative electrode, the positive electrode with LiNi_{0.5}Co_{0.2}Mn_{0.3}O₂ positive electrode active material applied, and the F-2 electrolyte as the electrolyte.

### Comparative Example 2 (Negative Electrode without Protective Layer)

The negative electrode and full cell were manufactured in the same manner as in Comparative Example 1, except that F-3 electrolyte was used as the electrolyte.

### Experimental Example 1: Evaluation of Lithium-Ion Binding Force and Satisfaction of Equation 1

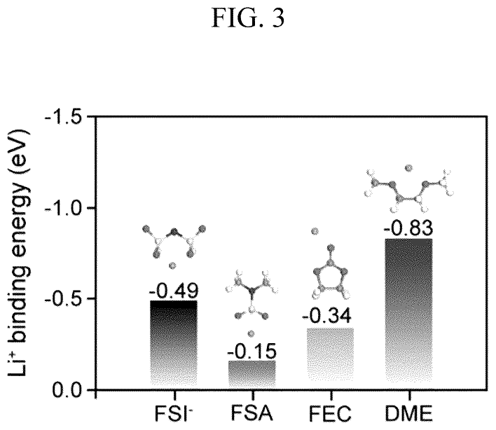

The lithium-ion binding capacity of FSI-anion, FSA organic solvent used in embodiments 1 and 2, conventionally generally-used FEC (Fluoroethylene carbonate) organic solvent, and DME (1,2-Dimethoxyethane) organic solvent was evaluated and is shown in FIG. 3 and Table 1 below.

TABLE 1

| | lithium-ion |
|---|---|
| | binding force |
| | (eV) |
| FSI⁻ | 0.49 |
| FSA | 0.15 |
| FEC | 0.34 |
| DME | 0.89 |

TABLE 2

| | BE_{Li}(anion) − |
|---|---|
| | BE_{Li}(organic solvent) |
| embodiment 1 | 0.34 |
| embodiment 2 | 0.34 |

Referring to FIG. 3 and Table 1, it was confirmed that the FSA organic solvent used in embodiments 1 and 2 had extremely low lithium-ion binding power, and accordingly, it was confirmed that the negative electrode manufactured according to embodiments 1 and 2 satisfied the following Equation 1.

$${BE}_{Li} ( anion ) - {BE}_{Li} ( organic solvent ) \geq 0.25 ( eV ) \qquad [ Equation 1 ]$$

In the Equation 1, BE_{Li}(anion) is the lithium-ion binding energy of the negative ion in the protective layer, and BE_{Li}(organic solvent) is the lithium-ion binding energy of the organic solvent in the protective layer.

### Experimental Example 2: Analysis of the Cause of Life-Span Characteristic Degradation of a Battery without a Protective Layer Applied

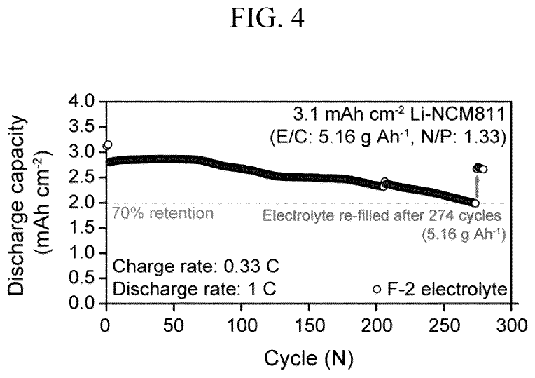

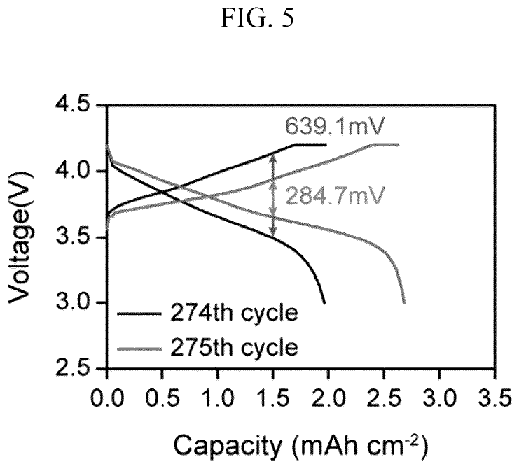

The initial capacity according to the cycle progression and the initial capacity after the additional addition of F-2 electrolyte were evaluated when operating a 20 m Li-NCM811 pouch cell injected with a small amount (5 g/Ah) of F-2 electrolyte, and the results are shown in FIG. 4 and FIG. 5.

FIG. 4 and referring to FIG. 5, it was found that the depletion of F-2 electrolyte was the cause of the life-span characteristic deterioration.

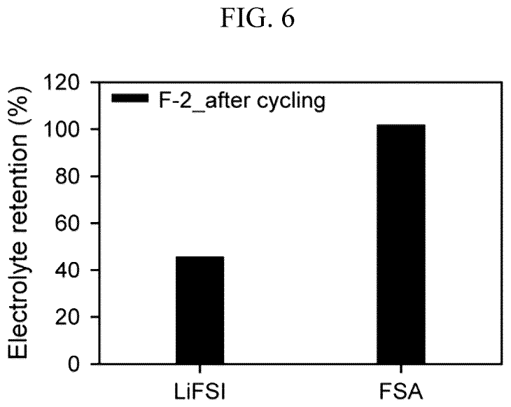

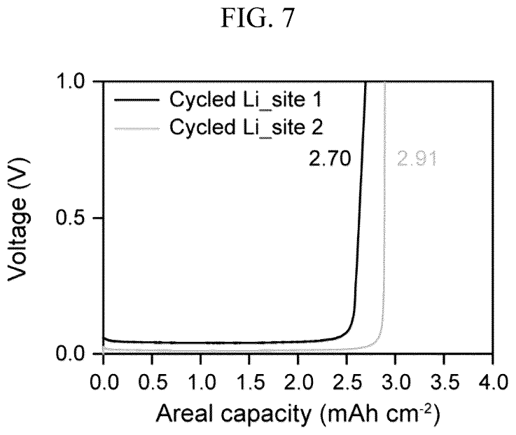

In addition, a 20 m Li-NCM811 pouch cell injected with a small amount (5 g/Ah) of F-2 electrolyte was operated and cycled to evaluate the electrolyte residual ratio of the degraded cell, which is shown in FIG. 6. The lithium reversible capacity of the degraded cell was evaluated, which is shown in FIG. 7.

Referring to FIG. 6 and FIG. 7, it was found that the decomposition of FSI-anion, particularly among F-2 electrolytes, was the direct cause of the life-span characteristic deterioration.

### Experimental Example 3: Raman Spectrum Analysis

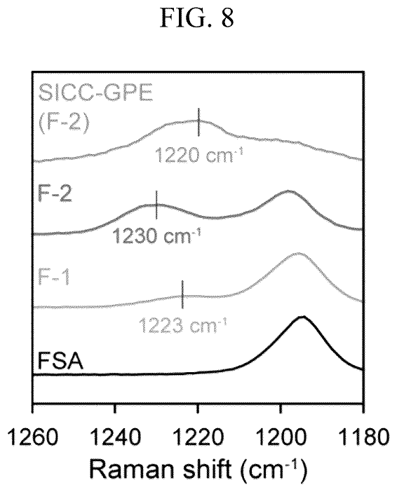

Raman spectrum analysis of the protective layer, F-2 electrolyte, 1M LiFSI dissolved FSA electrolyte, and FSA solvent in the negative electrode manufactured according to embodiment 1 was performed and is shown in FIG. 8.

Referring to FIG. 8, it was confirmed that very low coordination between lithium-ion and FSI anion was observed within the protective layer.

### Experimental Example 4: MD Simulation Analysis

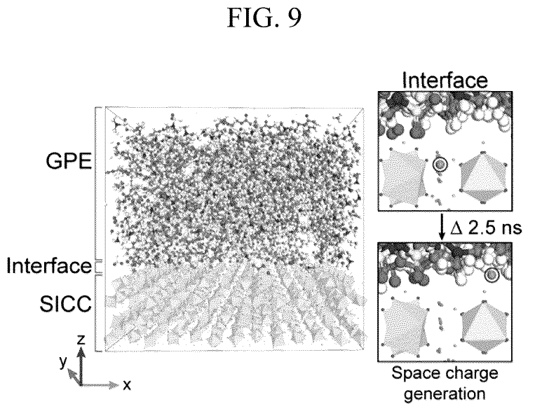

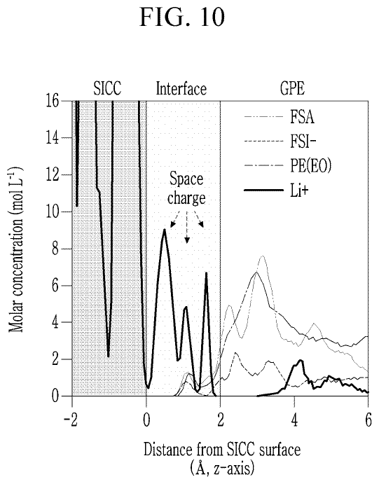

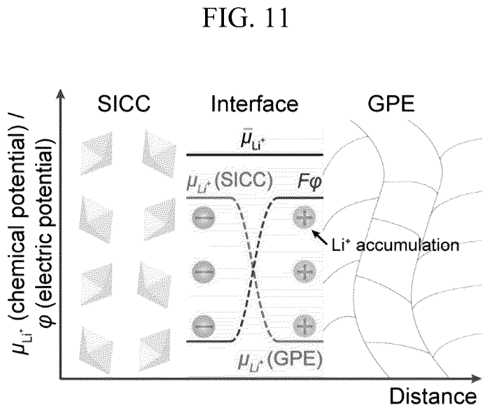

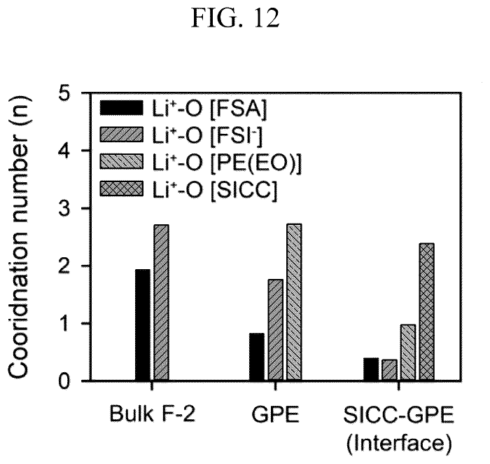

In order to clarify the experiment results of Experimental Example 3, MD simulation analysis was performed, and the resulting lithium-ion concentration result graph is shown in FIG. 9 to FIG. 11 and Table 3 below. In addition, the resulting graph of the coordination number of lithium-ion derived accordingly is shown in FIG. 12 and Table 4 below.

TABLE 3

| | average |
|---|---|
| | lithium-ion |
| | concentration(M) |
| lithium-ion conductive nano | 39 |
| particle | |
| Gel polymer electrolyte | 1.6 |

TABLE 4

| | Coordination | Coordination | Coordination | Coordination |
|---|---|---|---|---|
| | number | number | number | number |
| | between | between | between | between |
| | Li—O(FSA) | Li—O(FSI−) | Li—O(PEGDA) | Li—O(SICC) |
| F-2 electrolyte | 1.94 | 2.70 | | |
| Gel polymer | 0.83 | 1.76 | 2.73 | |
| electrolyte | | | | |
| Lithium-ion | 0.40 | 0.36 | 0.97 | 2.39 |
| conductive nano | | | | |
| particle - gel | | | | |
| polymer | | | | |
| electrolyte | | | | |
| interface region | | | | |

Referring to FIG. 9 to FIG. 12 and Table 3 to Table 4, it was confirmed that there was a clear difference in average lithium-ion concentration between lithium-ion conductive nano particles and gel polymer electrolyte, and that there was a lithium-ion concentration gradient in the interface region between them. In addition, it was confirmed that a space charge composed only of lithium-ions was formed in the interface region due to the chemical potential difference of these lithium-ions. In addition, it was confirmed that the coordination number between Li—O(FSA), Li—O(FSI⁻), and Li—O(PEGDA) in the interface region was significantly reduced compared to the electrolyte or gel polymer electrolyte region.

### Experimental Example 5: Evaluation of Lithium-Ion Average Decomposition Voltage

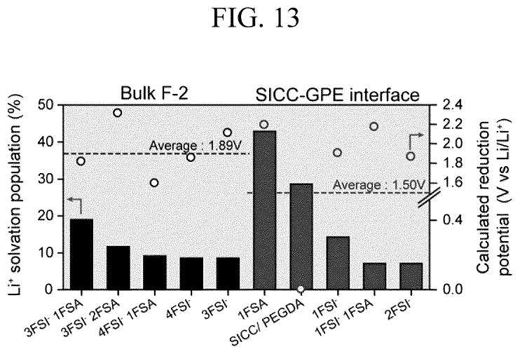

The lithium-ion average decomposition voltage in the lithium-ion conductive nano particle—gel polymer electrolyte interface region was evaluated through simulation calculations and is shown in FIG. 13.

Referring to FIG. 13, it was confirmed that the reduced lithium-ion—electrolyte coordination in the lithium-ion conductive nano particle—gel polymer electrolyte interface region can reduce not only the electrolyte decomposition but also the average decomposition voltage of lithium-ions during the lithium electrodeposition process.

### Experimental Example 6: Electrolyte Decomposition Current Evaluation

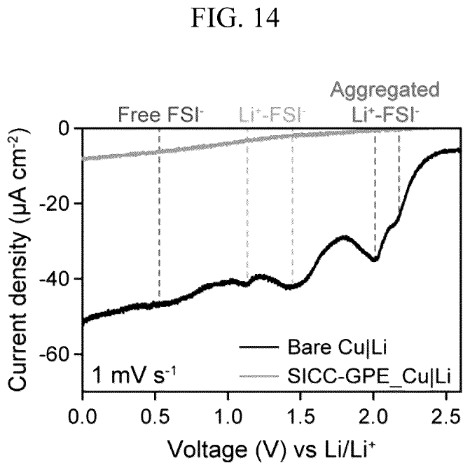

The electrolyte decomposition current was evaluated using linear sweep voltammetry by applying a Li/Cu half-cell to the negative electrode manufactured according to embodiment 1 and Comparative Example 1, and the results are shown in FIG. 14.

Referring to FIG. 14, in the case of Comparative Example 1 where no protective layer is applied, it was confirmed that a large amount of electrolyte decomposition current was observed even at a voltage of 2 V or higher. That is, in the case of embodiment, it was confirmed that electrolyte decomposition was reduced as the protective layer was applied.

### Experimental Example 7: Symmetric Cell Time-Dependent Impedance Evaluation

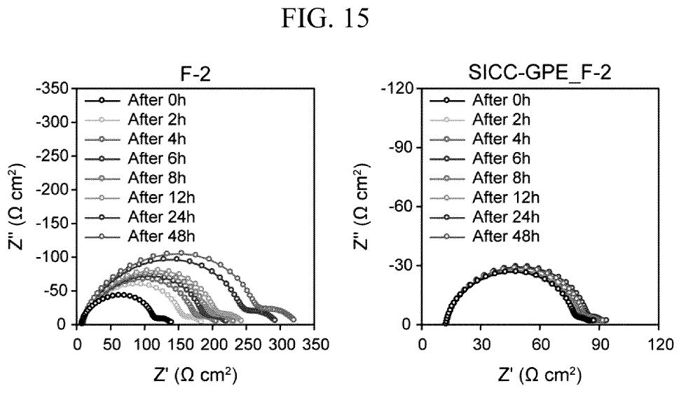

A symmetric cell was applied to the negative electrode manufactured according to embodiment 1 and Comparative Example 1, and the time-dependent impedance measurement of the cell was performed, which is shown in FIG. 15. The left graph in FIG. 15 is Comparative Example 1, and the right graph is the corresponding graph of embodiment 1.

Referring to FIG. 14, in the case of the Comparative Example, the interface resistance continuously increases due to continuous side-reaction during impedance measurement, but in the case of the embodiment, it was confirmed that the change in the resultant interface resistance with the protective layer applied was significantly reduced. Accordingly, it was confirmed that the structural/chemical stability increased when a protective layer was applied to the lithium metal layer.

### Experimental Example 8: Evaluation of Interface Resistance Increase Over Time in a Symmetric Cell

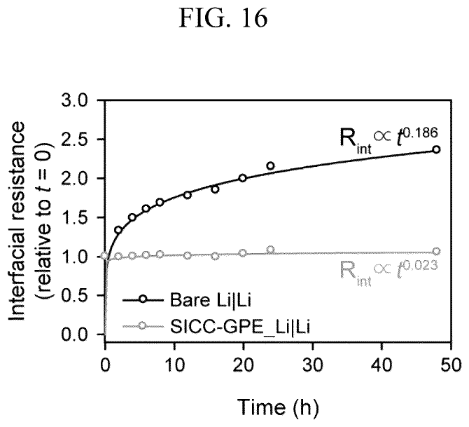

The initial interface resistance increase with time was evaluated by applying a symmetric cell to the negative electrode manufactured according to embodiment 1 and Comparative Example 1, and the results are shown in FIG. 16.

Referring to FIG. 16, for the embodiment, it was confirmed that the initial interface resistance with the protective layer applied remained almost constant over time, whereas for the Comparative Example, the initial interface resistance significantly increased over time. Accordingly, it was confirmed that the structural/chemical stability increased when a protective layer was applied to the lithium metal layer.

### Experimental Example 9: Evaluation of Full-Cell Life-Span Characteristic

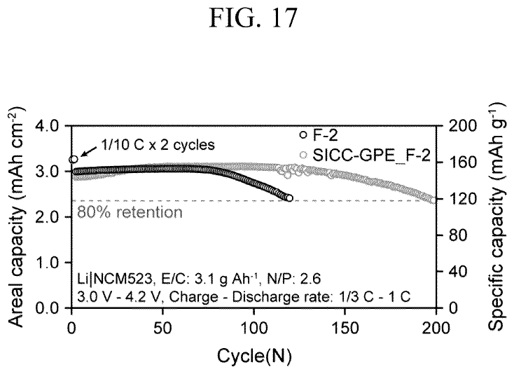

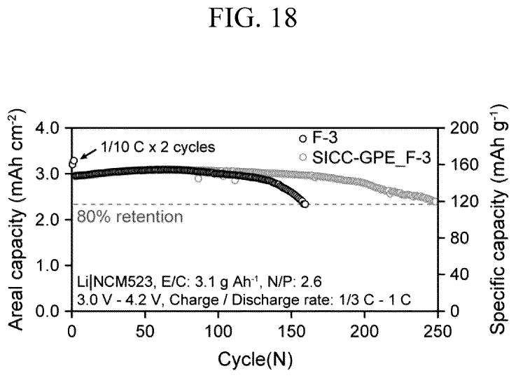

The life-span characteristics of the full cells manufactured according to Embodiments 1 to 2 and Comparative Examples 1 to 2 were evaluated and are shown in FIG. 17 (embodiment 1 and Comparative Example 1) and FIG. 18 (embodiment 2 and Comparative Example 2), and the cycle number at the point where the initial discharge capacity becomes 80% is shown in Table 5 below. Additionally, the life-span characteristic evaluation results of the full cell manufactured according to Comparative Examples 3 to 4 are shown in Table 4 below.

TABLE 5

| | Cycle number (the point at which |
|---|---|
| | the initial discharge capacity reaches 80%) |
| embodiment 1 | 200 |
| embodiment 2 | 250 |
| Comparative Example 1 | 120 |
| Comparative Example 2 | 160 |

Referring to FIG. 17 and FIG. 18, Table 5, it was confirmed that the negative electrode for a lithium rechargeable battery according to the embodiment in which the lithium-ion binding energy of the anion and the organic solvent was appropriately adjusted to the range according to the present disclosure had a superbly improved life-span characteristic compared to the Comparative Example in which this was not the case.

### Experimental Example 10: Evaluation of Component Analysis as Cycles Progress

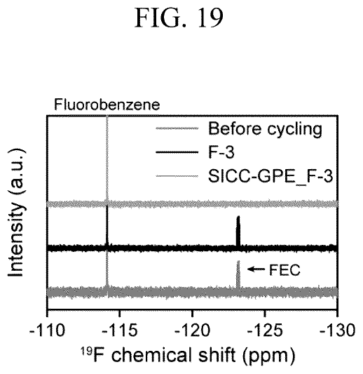

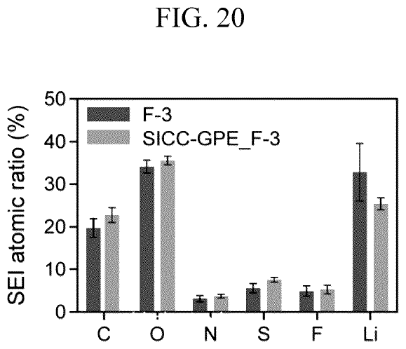

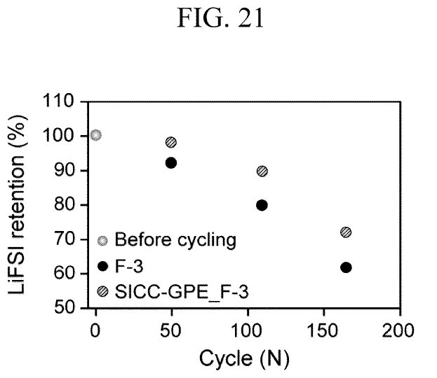

After 10 cycles in the full cell manufactured according to embodiment 2 and Comparative Example 2, 19F NMR analysis of the residual electrolyte was performed and the result is shown in FIG. 19. In addition, component element analysis within the SEI (Solid Electrolyte Interphase) film was evaluated by X-ray photoelectron spectroscopy (XPS) and the result is shown in FIG. 20. In addition, the LiFSI maintenance rate according to the cycle progression was evaluated and is shown in FIG. 21.

Referring to FIG. 19 and FIG. 20, for embodiment 2, unlike Comparative Example 2, it was confirmed that the low electrolyte decomposition voltage induced the decomposition of free FEC, and thus, all FEC was depleted as the cycle progressed. Accordingly, the ratio of carbon in the SEI film increased and the Li ratio decreased.

Referring to FIG. 21, in the case of embodiment 2, it was confirmed that the electrolyte decomposition was reduced throughout the entire cycle compared to Comparative Example 2, resulting in a higher LiFSI retention rate.

### Experimental Example 11: Evaluation of Negative Electrode Cross-Section Shape

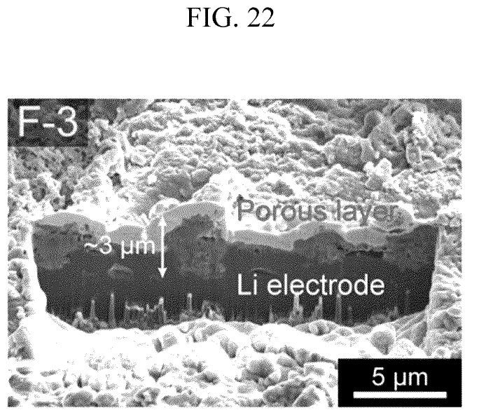

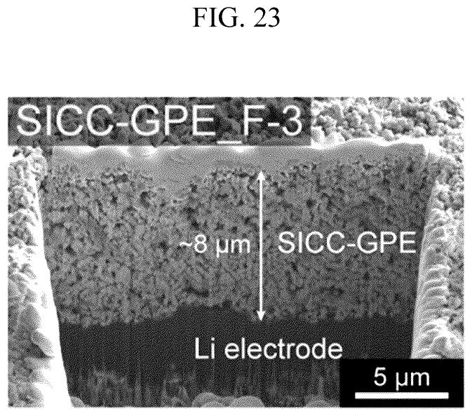

After 10 cycles of FIB milling of the negative electrode in the full cell manufactured according to embodiment 2 and Comparative Example 2, the cross-section SEM image was analyzed and is shown in FIG. 22 (Comparative Example 2) and FIG. 23 (embodiment 2).

In the case of FIG. 22 and referring to FIG. 23, embodiment, unlike the Comparative Example, it was confirmed that the porous layer deposition was suppressed as the electrolyte decomposition was reduced, and the porous layer was maintained with a uniform thickness. On the other hand, in the case of the Comparative Example, it was confirmed that the porous layer deposition increased compared to the embodiment, and an ununiform porous layer was found.

Meanwhile, it was confirmed that the thickness of the protective layer of the embodiment was approximately 8 m.

### Experimental Example 12: Cell Swelling Characteristic Evaluation

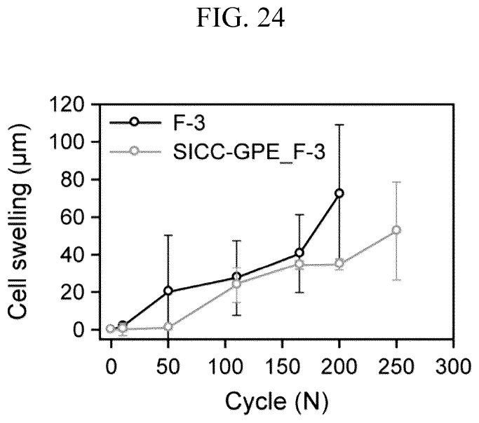

The degree of swelling according to the cycle progression of the full cell manufactured according to embodiment 2 and Comparative Example 2 was evaluated and is shown in FIG. 24.

Referring to FIG. 24, in the case of embodiment 2, it was confirmed that the degree of cell swelling also deteriorated as the deposition of the porous layer was suppressed as compared to Comparative Example 2 according to the progression of the cycle.

Although the present disclosure has been described above with regard to a preferably embodiment thereof, the present disclosure is not limited thereto, and it is possible to implement the present disclosure by modifying it in various ways within the scope of the patent claims and the detailed description and accompanying drawings of the disclosure, and this also naturally falls within the scope of the present disclosure.

Therefore, it can be said that the actual scope of the present disclosure is defined by the attached patent claims and their equivalents.

What is claimed is:

1. A negative electrode for lithium rechargeable battery, the negative electrode comprising:
a current collector;
a lithium-based negative electrode active material layer positioned on the current collector; and
a protective layer positioned on the lithium-based negative electrode active material layer,
wherein the protective layer comprises a gel polymer electrolyte and a lithium-ion conductive nano particle,
wherein the gel polymer electrolyte comprises a lithium-ion derived from lithium salt, an anion, an organic solvent, and a polymer, and
wherein a lithium-ion binding energy of the anion is greater than a lithium-ion binding energy of the organic solvent.

2. The negative electrode of claim 1, wherein the negative electrode satisfies:
BE_{Li}(anion)−BE_{Li}(organic solvent)≥0.25 (eV)
wherein BE_{Li}(anion) is the lithium-ion binding energy of the anion, and BE_{Li}(organic solvent) is the lithium-ion binding energy of the organic solvent.

3. The negative electrode of claim 1, wherein an average lithium-ion concentration of the lithium-ion conductive nano particle is higher than an average lithium-ion concentration of the gel polymer electrolyte.

4. The negative electrode of claim 1, wherein the gel polymer electrolyte and the lithium-ion conductive nano particle form an interface region between them, and the interface region has a lithium-ion concentration gradient.

5. The negative electrode of claim 1, wherein the average lithium-ion concentration of the lithium-ion conductive nano particle is greater than or equal to about 30 M, and the average lithium-ion concentration of the gel polymer electrolyte is less than or equal to about 3 M.

6. The negative electrode of claim 4, wherein the interface region forms a space charge composed of lithium-ions.

7. The negative electrode of claim 4, wherein a coordination number between lithium-ion and anion in the interface region is about 1 or less.

8. The negative electrode of claim 4, wherein a coordination number between lithium-ion and organic solvent in the interface region is about 0.5 or less.

9. The negative electrode of claim 4, wherein a coordination number between lithium-ion and lithium-ion conductive nano particle in the interface region is more than or equal to about 50% of the entire coordination number of lithium-ions.

10. The negative electrode of claim 1, wherein the lithium salt is LiFSI (Lithium Bis(fluorosulfonyl)imide), LiTFSI (Lithium bis(trifluoromethanesulfonyl)imide), LiBF₄ (Lithium tetrafluoroborate), LiPF₆ (Lithium hexafluorophosphate), LiBOB(Lithium bis(oxalato)borate) or a combination thereof.

11. The negative electrode of claim 1, wherein the organic solvent is FSA (N,N-dimethylsulfamoyl fluoride), DME (1,2-dimethoxyethane), FEC (Fluoroethylene carbonate) or a combination thereof.

12. The negative electrode of claim 1, wherein the polymer is formed by cross-linking polymerization compounds, and the polymerization compounds are PEGDA (Poly(ethylene glycol) diacrylate), PEGDMA (polyethylene glycol dimethacrylate), PEG (poly(ethylene glycol)), and EGDMA (Ethylene glycol dimethacrylate), PEGDE (Poly(ethylene glycol) diglycidyl ether) or a combination thereof.

13. The negative electrode of claim 12, wherein a molecular weight of the polymerization compound is about 500 to 5,000 g/mol, and a molecular weight of the polymer is about 10,000 to 1,000,000.

14. The negative electrode of claim 1, wherein the lithium-ion conductive nano particle is an oxide nano particle.

15. The negative electrode of claim 1, wherein the lithium-ion conductive nano particle is LLZO type oxide, LSTP type oxide, LATP type oxide, LAGP type oxide, LLTO type oxide, LGPO type oxide or a combination thereof.

16. The negative electrode of claim 1, wherein the lithium-ion conductive nano particle is an LLZO type oxide represented by:
LiₐM1_{b}La_{c}Zr_{d}M2ₑO_{f}
wherein M1 is Al, M2 is Ta, Nb, W or a combination thereof, 5≤a≤7, 0≤b≤3, 2≤c≤4, 1≤d≤3, 0≤e≤2, and 10≤f≤14.

17. The negative electrode of claim 1, wherein an average particle diameter D50 of the lithium-ion conductive nano particle is about 100 nm to 5 m.

18. The negative electrode of claim 1, wherein a weight ratio of the sum of the lithium-ion conductive nano particle, the lithium salt, and the polymer (lithium-ion conductive nano particle:lithium salt+polymer) is about 5:5 to 9:1, and wherein a weight ratio of the lithium salt and the polymer (lithium salt:polymer) is about 2:8 to 9:1.

19. The negative electrode of claim 1, wherein a thickness of the protective layer is about 1 to 20 m.

20. A lithium rechargeable battery, comprising a negative electrode for a lithium rechargeable battery of claim 1.
